(19) United States
(12) Patent Application Publication
(10) Pub. No.: US 2005/0102194 A1
(43) Pub. Date: May 12, 2005

(54) Method, system, and computer program product for filtering participants in electronic transactions using privacy policies

(75) Inventors: David G. Kuehr-McLaren, Apex, NC (US); Martin Presler-Marshall, Chapel Hill, NC (US); Calvin S. Powers, Chapel Hill, NC (US); Timothy Shoriak, Cary, NC (US); John H. Walczyk III, Raleigh, NC (US)

Correspondence Address: SYNNESTVEDT & LECHNER, LLP, 2600 ARAMARK TOWER, 1101 MARKET STREET, PHILADELPHIA, PA, 191072950, US

(73) Assignee: International Business Machines Corporation, Armonk, NY (US)

(21) Appl. No.: 10/706,464

(22) Filed: Nov. 12, 2003

(51) Int. Cl. G06F 17/60

(52) U.S. Cl. 705/26

(57) ABSTRACT

Parties involved in transacting business in an E-marketplace (E-marketplace participants) each identify and submit to the E-marketplace relevant characteristics related to their privacy-use needs (those that they adhere to, referred to as “privacy policies”; those that they require, referred to as “privacy preferences”, or both). The privacy policies and privacy preferences of the E-marketplace participants are then matched up, and those with matching characteristics are given access to each other, while those that do not match up are denied access to each other. This serves as a search filter to match up consumers with providers.

### BACKGROUND OF THE INVENTION

1. Field of the Invention

The present invention relates to the use of privacy policies in computer-based on-line commerce in which sellers and buyers of goods or services are linked via an electronic marketplace where deals are negotiated and consummated.

2. Description of the Related Art

As networks of linked computers become an increasingly more prevalent concept in everyday life, on-line interactions between buyers and sellers have become commonplace. Transactions between a business and an individual consumer are referred to as business-to-consumer (B2C) transactions and transactions between businesses (e.g., the sale of goods from a manufacturer to a wholesaler who uses the purchased goods to eventually sell a product on the retail level) are referred to as business-to-business (B2B) transactions.

As a result of this increased use of networked computers to transact business, the concept of the electronic marketplace, referred to herein as the “E-marketplace,” has emerged and become a standard form of conducting these business transactions. For a variety of reasons, the intermediary function provided by the E-marketplace is now an everyday part of transactional commerce.

On the consumer end, E-commerce sites such as E-Bay, half.com, Ubid.com, and AuctionPort.com provide an E-marketplace serving as a central location for negotiation of sales and/or auctions of products or services from a seller to a consumer (e.g., bidders). Likewise, B2B sellers provide a similar intermediary service for business transactions between businesses.

A significant trade off for enjoying the convenience of e-commerce is the need to submit to a semi-public forum what would typically be considered private information. For example, to do business on an e-commerce site, it is usually necessary to provide any or all of the following: name, address, telephone number, email address, credit card numbers, demographic information and the like. For B2B, this information might include banking information, pricing information, inventory information, and personal information pertaining to company contacts. This quite naturally concerns users of e-commerce since once submitted to the e-commerce site, the user loses control of the use of the information by others. This invariably stops some users from utilizing e-commerce sites to make purchases, despite the convenience that they offer.

As a result of the above problems, steps have been taken to develop methods for protecting the privacy of e-commerce users while allowing the e-commerce sites to function. As an example, the Platform for Privacy Preferences Project (P3P) was developed by the World Wide Web Consortium and has emerged as an industry standard providing a simple, automated way for users to gain more control over the use of personal information on websites that they visit. P3P is a standardized set of multiple-choice questions, covering all the major aspects of a website's privacy policies. Taken together, they present a clear snapshot of how a site handles personal information about its users. P3P-enabled websites make this information available in a standard, machine-readable format. P3P-enabled browsers can “read” this snapshot automatically and compare it to the consumer's own set of privacy preferences. P3P enhances a user's control by putting privacy policies where users can find them, in a form users can understand, and most importantly, enables users to act on what they see.

While functioning adequately, use of P3P or other systems to specify privacy information in an E-marketplace can be quite cumbersome. A declaration of a privacy policy that characterizes an entire particular marketplace is difficult to identify and to express. An E-marketplace administrator can require all participants to adhere to one particular privacy policy, either overall or even on a section-by-section basis of the marketplace (e.g., all electronics vendors adhere to one privacy policy, all service providers adhere to another privacy policy, etc.), but requiring this adherence will limit the number of willing seller participants. Similarly, the marketplace could invoke a privacy statement that only applies to the portal (e.g., “This website adheres to the following privacy policies . . . ”), but this would not prevent the individual participants from following different privacy policies, and thus would likely discourage potential buyers from participating in the E-marketplace.

This becomes especially difficult in B2B and B2C exchanges where an E-marketplace portal represents many customers, suppliers, shippers, and manufacturers that may or may not have web objects on the portal, but will be privy to some or all of the information that flows in a transaction. The information supplied in an E-marketplace form will likely be shared with multiple vendors. The use of this information will depend on the individual privacy policy of the parties involved in the transaction, and at each juncture in the transaction, the consumer's set of privacy preferences will have to be compared with those of each party to the transaction, an annoying and time-consuming process.

### SUMMARY OF THE INVENTION

In accordance with the present invention, parties involved in transacting business in an E-marketplace (E-marketplace participants) each identify and submit to the E-marketplace relevant characteristics related to their privacy policy needs (those that they adhere to, referred to as “privacy policies”; those that they require, referred to as “privacy preferences”, or both). Typically, this would occur during the registration process when an E-marketplace participant first registers with the E-marketplace, but could be defined per transaction. The privacy policies and privacy preferences of the E-marketplace participants are then matched up, and those with matching characteristics are given access to each other, while those that do not match up are either denied access. This serves as a search filter to match up consumers with providers.

Numerous other variations will be apparent from the description and claims herein.

### BRIEF DESCRIPTION OF THE DRAWINGS

FIG. 1 illustrates a typical E-marketplace environment in which the present invention can be practiced; and

FIG. 2 is a flowchart illustrating an example of basic steps performed in accordance with the present invention;

FIG. 3 illustrates an example of a GUI screen in accordance with the present invention whereby a user of the E-Marketplace (a buyer in this example) is shown a “Buyer Preferences” window when registering with the E-Marketplace;

FIG. 4 illustrates an example of a GUI screen in accordance with the present invention of a similarly simplified set of questions posed to “providers” (e.g., sellers, shippers, insurers, etc) in the E-Marketplace (“Seller 01” in this example);

FIG. 5 illustrates an example of a GUI screen in accordance with the present invention whereby the same questions are posed to another seller (Seller 02);

FIG. 6 illustrates a simulated screen capture of a GUI screen in accordance with the present invention showing a listing of potential sellers for the Buyer in this example.

### DETAILED DESCRIPTION OF THE PREFERRED EMBODIMENTS

In accordance with the present invention, parties utilizing an E-marketplace (e.g., buyers, sellers, and support parties such as insurers, deliverers, etc.) provide privacy-use information, (i.e., privacy policy and/or privacy preferences), as part of a registration process for the E-marketplace or as an automated process. As an administrative task of the E-marketplace, these privacy-policy requirements are gathered, reviewed, and used to match participants having the same requirements.

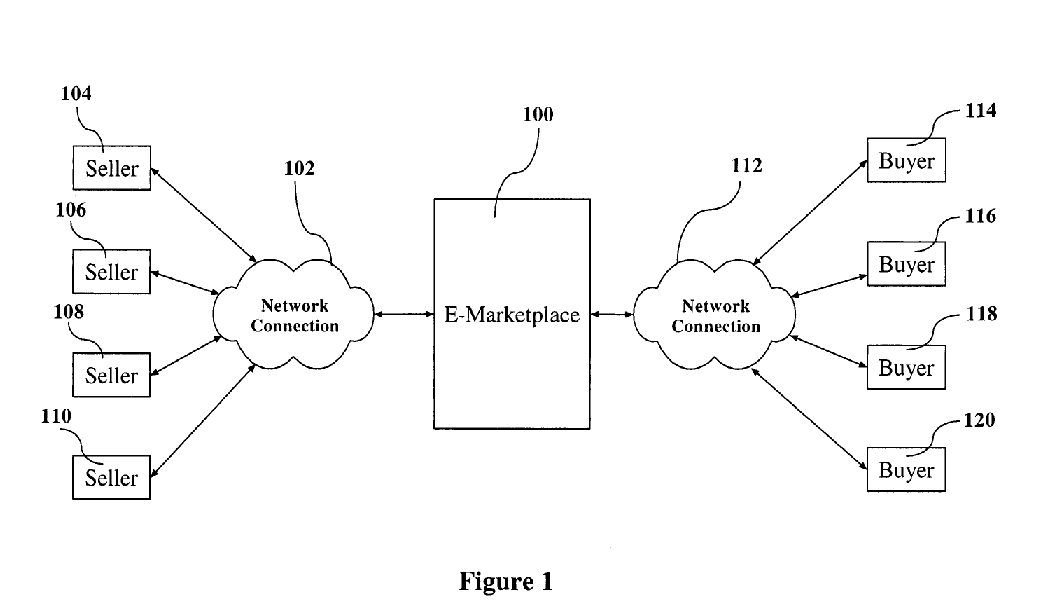

FIG. 1 illustrates a typical E-marketplace environment in which the present invention can be practiced. An E-marketplace 100 is coupled to a plurality of sellers 104, 106, 108 and 110 via a network connection 102 (e.g., the Internet). Similarly, E-marketplace 100 is connected to a plurality of buyers 114, 116, 118, and 120 via a network connection 112. Typically, the E-marketplace 100 will comprise a server configured to receive communications from the network connections 102, 112, store information for viewing by parties connected to the network connections 102 and 112, and store other information pertaining to transactions which may occur in the E-marketplace. Sellers 104, 106, 108, and 110, and buyers 114, 116, 118, and 120, typically use PC workstations, PDA's, networks, wireless devices, or other network communication devices for accessing the E-marketplace via the network connections 102 and 112.

In a typical electronic transaction using the environment illustrated in FIG. 1, a seller, e.g., seller 104, will connect to E-marketplace 100 via the network connection 102 and register with the E-marketplace. Seller 104 may identify itself by a pseudonym and typically will be required to also provide true name, address, e-mail address and other identity information for identification purposes.

In accordance with the present invention, if seller 104 is an individual (or is not a web-based business) seller 104 also provides privacy-use information (e.g., as part of an HTTP request or in an attribute certificate) as part of the registration process. This privacy-use information is used by potential purchasers to evaluate purchases, as well as by the E-marketplace to attract potential purchasers. If seller 104 is a business, then as part of the registration process, it provides its P3P policy (or its location on the seller's server) to the E-marketplace.

This privacy-use information may include the seller's policy regarding sale of email lists, use of sales information, protection of credit card numbers and other personal information, demographic information and the like.

The same type of information can be provided to the E-marketplace by potential buyers. For example, buyer 114 provides an attribute certificate to E-marketplace 100 via network connection 112 as part of the registration process. The attribute certificate from the buyer includes privacy-use information pertaining to them, including for example, their decisions regarding use of private information such as email address, name and address information, credit card information and any other personal or business-related information that could be considered private. For example, the buyer 114 might not mind that the E-marketplace uses demographic information for marketing and other purposes, but does not want its email address sold. This kind of information would be included in the attribute certificate (or an HTTP request) sent during the registration process, or per transaction.

The E-marketplace administrator (or administration software that automatically operates on the E-marketplace server) receives all of the privacy-policy information from the participants, organizes it (and categorizes it if desired) and then performs a “matching process” whereby participants having the same privacy-use requirements are made aware of each other. Thus, a participant who has no interest in dealing with a seller who will sell its email address will not have vendors that have indicated that they will sell email addresses included in the list of potential sellers available for that participant. Likewise, if a seller has no interest in selling to consumers who do not want their email address sold, they too will be filtered out so that the seller will only see as available consumers those who have indicated that they do not mind that their email address be sold.

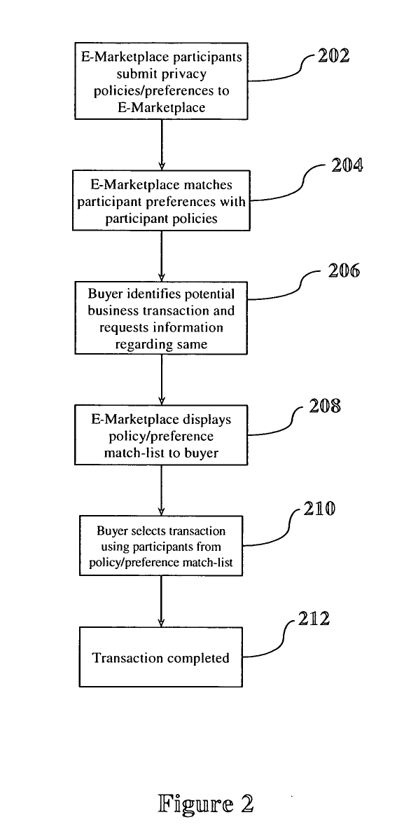

FIG. 2 is a flowchart illustrating an example of the basic steps performed in accordance with the present invention. At step 202, an E-marketplace participant submits its privacy-use information (e.g., policies and/or preferences) to the E-marketplace. This may involve completion of a form provided by the E-marketplace that solicits specific privacy-use information regarding the participant, or the submission of an attribute certificate, or the identification of an address or a web-server where a P3P policy resides.

At step 204, the E-marketplace matches participant preferences with participant policies and vice versa. This process involves identifying the choices made by all participants and locating other participants that fall within the criteria set forth in their selections. The various matches are correlated and stored in a database or other form for later retrieval and use.

At step 206, a buyer accesses the E-marketplace via the network connection and identifies a particular desired purchase or potential business transaction of interest and requests a list of participants that can provide the purchase or facilitate the transaction. This can comprise the simple action of clicking on an icon identifying the transaction, or any other known means of selecting information from an E-marketplace.

At step 208, the E-marketplace displays a policy/preference match-list to the buyer. This match-list is a list of all E-market participants able to fulfill the purchase interests of the buyer that meet the policy preferences of the buyer. Accordingly, potential participants that, but for their privacy policy would be considered as potential participants in the transaction desired by the buyer are filtered out and the buyer is assured of seeing only participants (e.g., sellers) that meet its needs.

At step 210, the buyer selects a transaction using one or more participants listed in the policy/preference match-list. At this point, the transaction commences in accordance with a normal E-commerce transaction within this E-marketplace and at step 212 the transaction is completed.

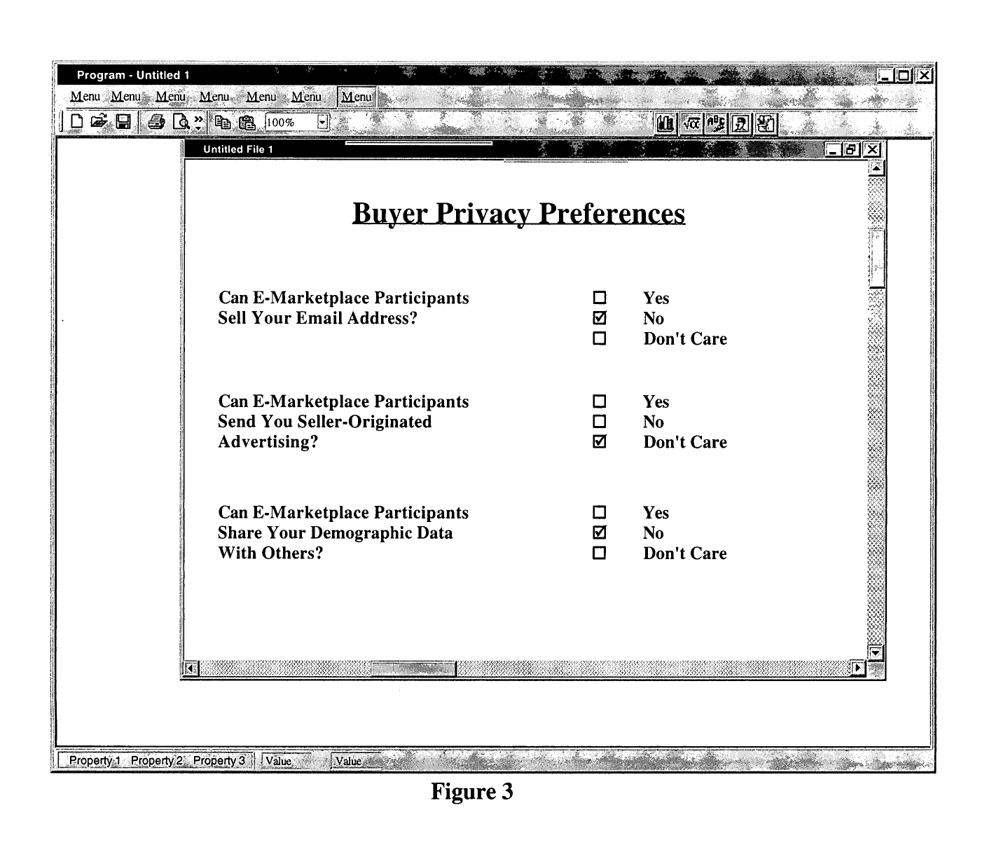

The following example illustrates an example of the use of the present invention in an E-Marketplace environment, and shows simulated screen captures (FIGS. 3-6) from a graphical user interface (GUI), illustrating how the present invention might be implemented for use in such an environment. In the example of FIG. 3, a user of the E-Marketplace (a buyer in this example) is shown a “Buyer Preferences” window when registering with the E-Marketplace. As can be seen in FIG. 3, which is an extremely simplified example used only for the purpose of explanation, the Buyer is required to answer a series of questions (three in this example) which will solicit from the Buyer his or her preferences regarding use of privacy data. Thus, as shown in the example of FIG. 3, the Buyer is asked the following questions:
1. Can E-Marketplace Participants Sell Your Email Address?
2. Can E-Marketplace Participants Send You Advertising That They Originate?
3. Can E-Marketplace Participants Share Your Demographic Data With Others?
   and are given the opportunity to answer (by checking a box) with either “Yes”, “No”, or “Don't Care”.

In the example illustrated in FIG. 3, the Buyer has answered “No” to the sale of email question; “Don't Care” to the receipt of seller-originated advertising; and “No” to the sharing of demographic data question.

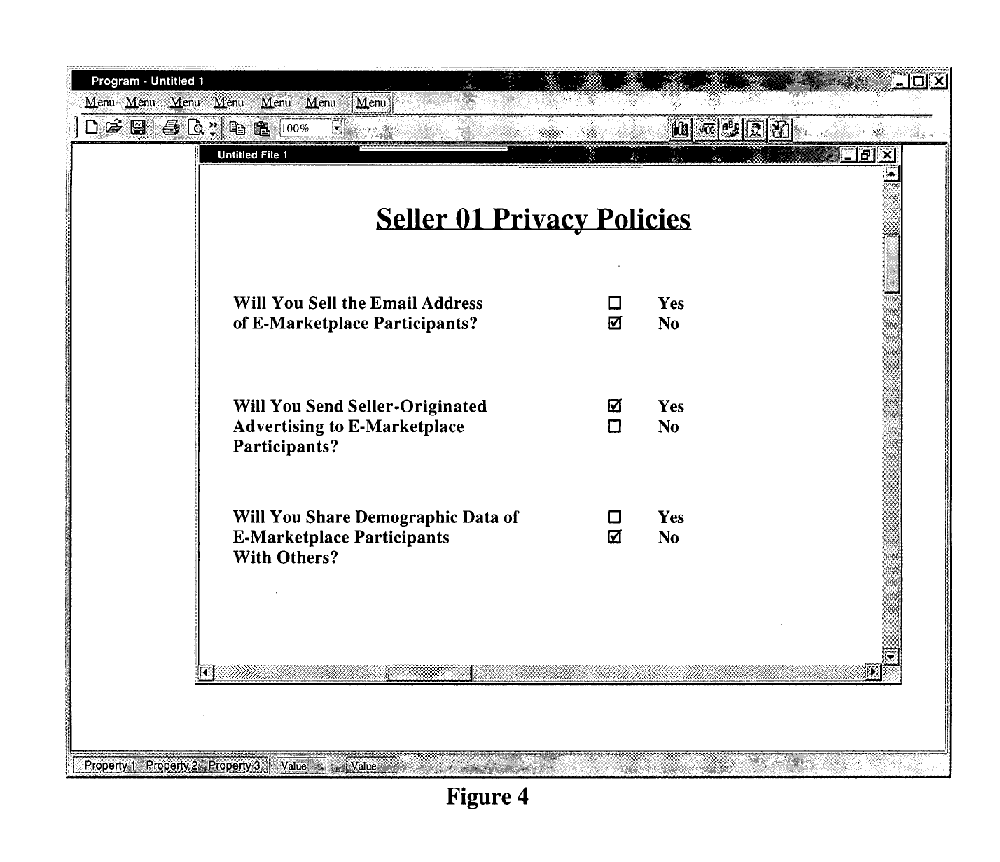

FIG. 4 illustrates a GUI display of a similarly simplified set of questions posed to “providers” (e.g., sellers, shippers, insurers, etc) in the E-Marketplace (“Seller 01” in this example). The questions posed to Seller 01 are directed to its privacy policies under which they operate. As can be seen, the questions correspond to those asked of the Buyer in FIG. 3, that is, Seller 01 provides information regarding whether or not they sell email addresses; send advertising to E-marketplace participants; and share demographic data of participants with others. In this example, Seller 01 has indicated it will not sell email addresses; that they will send seller-originated advertising to participants; and that they will not share demographic data of participants with others.

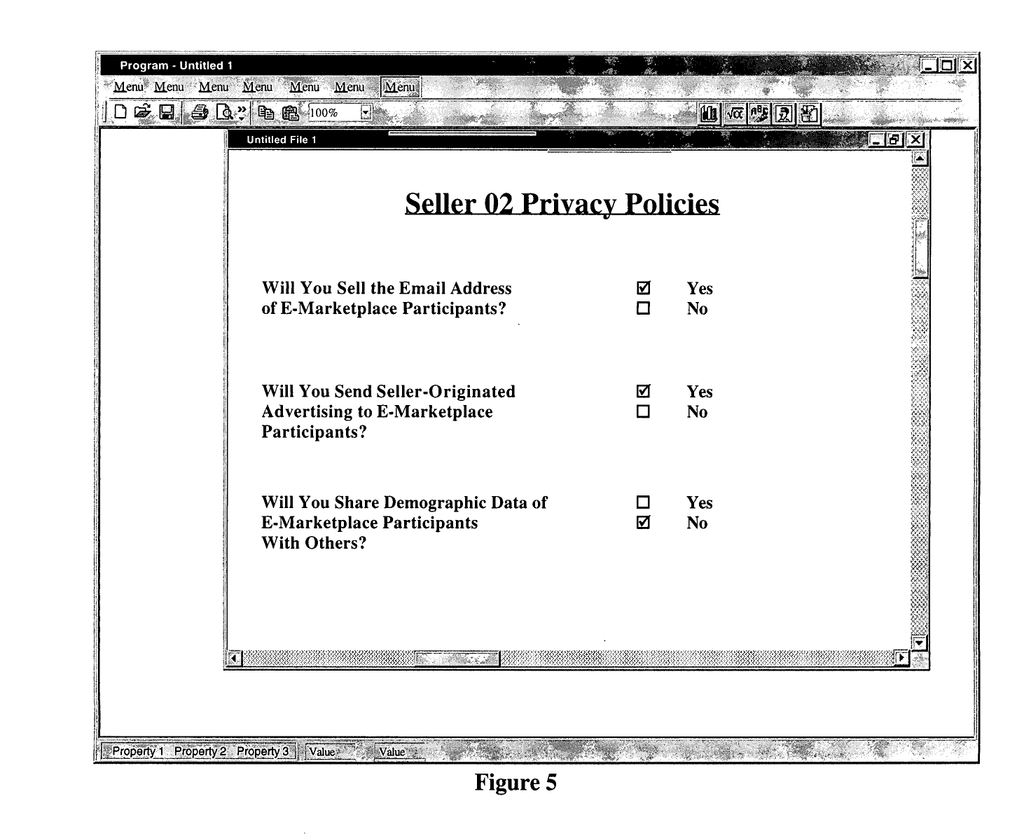

FIG. 5 illustrates the same questions to another seller (Seller 02). As can be seen, Seller 02 will sell email addresses to E-marketplace participants; will send seller-originated advertising; and will not share demographic data of participants with others.

For each provider in the E-marketplace, the same questions are posed and their responses recorded and compiled. For purposes of example, only two representative GUI displays are shown (FIG. 4 for Seller 01 and FIG. 5 for Seller 02); however, it is understood that there will typically be many providers in the E-marketplace and this information will be solicited for each provider.

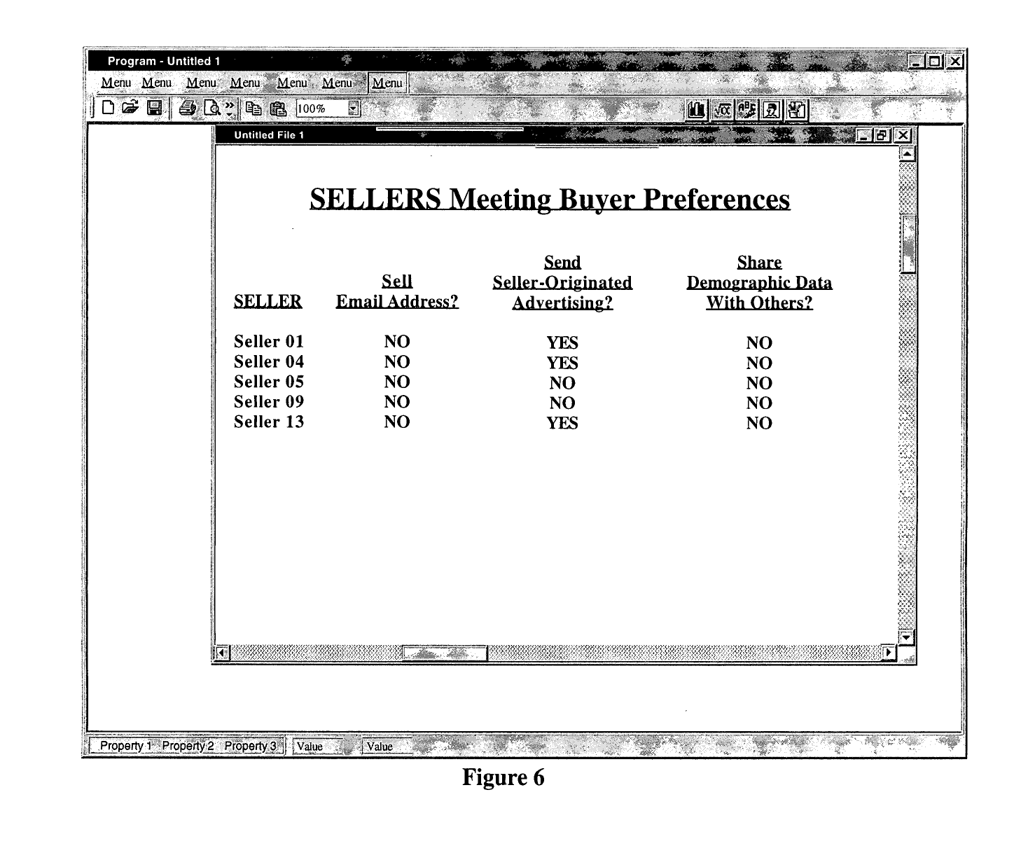

FIG. 6 illustrates a simulated screen capture of a GUI screen showing a listing of potential sellers for the Buyer in this example. The simulated screen capture of FIG. 6 shows Seller 01 of FIG. 4, as well as others (Seller 04, Seller 05, Seller 09, and Seller 13) that have responses that meet the Buyer's preferences (the individual response pages for each are not shown, for purposes of brevity). As can be seen, the list displays only sellers that meet the preferences of the Buyer. Seller 01 (of FIG. 4) is shown as meeting the Buyer's preferences, since Seller 01's responses to the privacy-use questions match the preferences expressed by the Buyer. Seller 02 is not shown, since it indicated that it would sell email addresses (see FIG. 5), contrary to the preferences of the Buyer.

The above-described steps can be implemented using standard well-known programming techniques. The novelty of the above-described embodiment lies not in the specific programming techniques but in the use of the steps described to achieve the described results. Software programming code which embodies the present invention is typically stored in permanent storage of some type, such as in the permanent storage of a workstation or server maintained by the E-Marketplace. In a client/server environment, such software programming code may be stored with storage associated with a server. The software programming code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

Although the present invention has been described with respect to a specific preferred embodiment thereof, various changes and modifications may be suggested to one skilled in the art and it is intended that the present invention encompass such changes and modifications as fall within the scope of the appended claims.

1. A method of conducting electronic commerce transactions among participants in an E-marketplace, comprising the steps of:
obtaining privacy-use information for each participant;
comparing the privacy-use information for each participant to determine matches;
only allowing transactions to occur between participants who have matching privacy-use information

2. The method of claim 1, wherein said obtaining step comprises at least the step of requiring each participant in the E-marketplace to present to the E-marketplace their P3P policy.

3. The method of claim 1, wherein said obtaining step comprises at least the steps of:
presenting each participant with questions that elicit their privacy-use information; and
storing the elicited privacy-use information for use in said comparing step.

4. The method of claim 3, wherein said privacy-use information includes at least one of: use information pertaining to elicited email addresses; use information pertaining to financial information; use of personal information; use of business information, and the delivery of advertising to the participant.

5. A system for conducting electronic commerce transactions among participants in an E-marketplace, comprising:
means for obtaining privacy-use information for each participant;
means for comparing the privacy-use information for each participant to determine matches;
means for only allowing transactions to occur between participants who have matching privacy-use information

6. The system of claim 5, wherein said means for obtaining comprises at least means for requiring each participant in the E-marketplace to present to the E-marketplace their P3P policy.

7. The system of claim 5, wherein said means for obtaining comprises at least:
means for presenting each participant with questions that elicit their privacy-use information; and
means for storing the elicited privacy-use information for use in said comparing step.

8. The system of claim 7, wherein said privacy-use information includes at least one of: use information pertaining to elicited email addresses; use of information pertaining to financial information; use of personal information; use of business information, and the delivery of advertising to the participant.

9. A computer program product recorded on computer-readable storage medium, for conducting electronic commerce transactions among participants in an E-marketplace, comprising:
computer-readable means for obtaining privacy-use information for each participant;
computer-readable means for comparing the privacy-use information for each participant to determine matches;
computer-readable means for only allowing transactions to occur between participants who have matching privacy-use information

10. The computer program product of claim 9, wherein said computer-readable means for obtaining comprises at least computer-readable means for requiring each participant in the E-marketplace to present to the E-marketplace their P3P policy.

11. The computer program product of claim 9, wherein said computer-readable means for obtaining comprises at least:
computer-readable means for presenting each participant with questions that elicit their privacy-use information; and
computer-readable means for storing the elicited privacy-use information for use in said comparing step.

12. The computer program product of claim 11, wherein said privacy-use information includes at least one of: use information pertaining to elicited email addresses; use of information pertaining to financial information; use of personal information; use of business information, and the delivery of advertising to the participant.
